(19) United States
(12) Patent Application Publication
(10) Pub. No.: US 2009/0288612 A1
(43) Pub. Date: Nov. 26, 2009

(54) SUBMERSIBLE MOORING GRID

(76) Inventor: Karsten Himmelstrup, Wilmington, DE (US)

Correspondence Address: YORAM TSIVION, P.O. BOX 1307, PARDES HANNA, 37111, IL

(21) Appl. No.: 12/302,800

(22) PCT Filed: May 30, 2007
(86) PCT No.: PCT/IB07/01422

§ 371 Date: Nov. 27, 2008

(30) Foreign Application Priority Data
May 30, 2006 (GB) 0610589.4

(51) Int. Cl. A01K 61/00; B63B 21/00; B63B 45/00; B63B 22/00

(52) U.S. Cl. 119/223; 114/230.1; 441/11

(57) ABSTRACT

A mooring grid having at least one mooring line submersible at a changeable depth. The mooring line consists of a substantially horizontal linear array of interconnected caissons and a plurality of suspended members connected each to a respective caisson. The suspended members are selected from a group consisting of cables, ropes, hawsers, chains and combinations of a hawser and a chain.

### FIELD OF THE INVENTION

The present invention relates in general to marine-culture. More specifically, the invention relates to submersible mooring grids for retaining devices such as fish-cages.

### BACKGROUND OF THE INVENTION

Cages for raising fish are typically located in sheltered fiords or bays that present no extreme sea conditions which may jeopardize cage security and maintenance. Most cages can withstand limited wave energy and mechanical stress applied by currents. Most of these systems are stationed in a fixed location employing a variety of mooring systems that take into account the direction of the prevailing sea currents.

Practicing aquaculture in open sea requires adaptation of the cages to extreme sea states. U.S. Pat. No. 4,257,350 discloses a device for practicing aquaculture in the open sea. The disclosed device includes a bow net means of rigid construction having means permitting it to float partially submerged or fully immersed in the water without touching the bottom of the sea. The bow net means includes constant-buoyancy tanks and variable-buoyancy tanks, the latter being adapted to be filled with either air or water. When filled with air the submersible cage floats on the surface of the water. In a case of a storm notice these tanks are filled with water, which in turn causes the cage to be fully immersed at a depth unaffected by the rough sea.

The structural elements of fish cage assembly as commonly used today is described schematically with reference to FIG. 1. Cage 8 is connected by a hawser 10 to anchor 12 lying on the bottom of sea 14. Cage 8 is stabilized by means of ballasts 13 suspended from its frame. Flexible air duct 16 terminating in buoy 18 provides for pressurizing air into the variable buoyancy tanks, not shown, attached to cage 8 providing for its floatation. Phantom lines show fully submerged cage 8. However, the cages are individually submerged and/or floated and therefore have to be equipped with respective buoyancy means. Hence a more user-friendly system consisting of simpler cages is called for.

### BRIEF DESCRIPTION OF THE DRAWINGS

FIG. 1 is a schematic side view of a submersible fish cage of prior art;

FIG. 2A is a schematic topside view of a section of a submersible mooring grid according to a preferred embodiment of the present invention;

FIG. 2B is a schematic side view of a mooring line of the submersible mooring grid shown in FIG. 2A;

FIG. 2C is a schematic side view of the mooring line shown in FIG. 2B disposed at a deeper level;

FIG. 3 is a schematic side view of a submersible mooring grid retaining fish cages according to a preferred embodiment of the present invention;

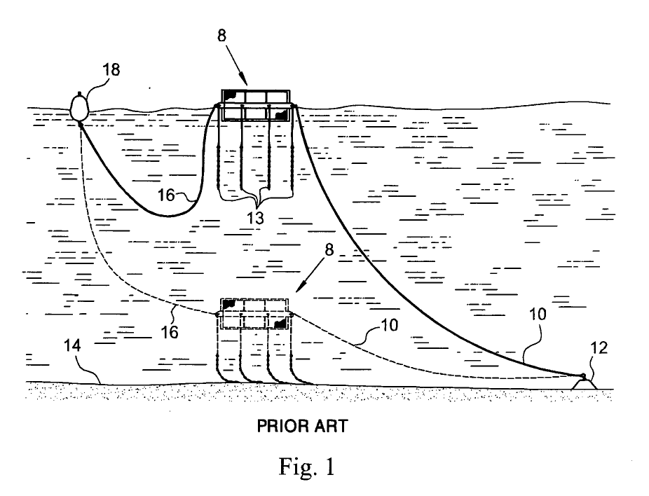

### DETAILED DESCRIPTION OF THE PRESENT INVENTION

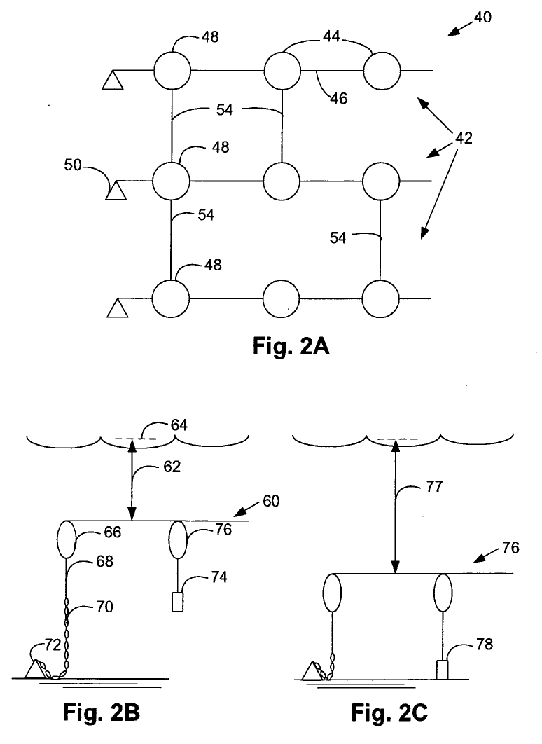

In accordance with the present invention, a submersible mooring grid especially suitable for retaining cage systems for fish culture is provided. In the following description the term fish relates to all kinds of sea dwelling animals such as fish, mollusks, clams and or crustaceans used as food. Fish cages and/or net cages are referred to hereinafter as fish cages. Submersible mooring grid according to a preferred embodiment of the present invention is hereby described with reference to FIGS. 2A-2C. In FIG. 2A a schematic topside view of section 40 of a submersible mooring grid is shown. One or more mooring lines 42 are disposed at a specified depth below the sea surface. Each of the mooring lines of a submersible grid consists of a horizontal linear array of interconnected caissons whose buoyancies are changeable. Such are, for example, pneumatic caissons having one or more hollow compartments that can be filled either with air or water. Adjacent caissons in a mooring line such as caissons 44 are connected by connecting hawser 46. At least one of the caissons of the submersible grid, such as caissons 48, is connected to anchor 50 disposed on the seabed. Optionally, hawsers or cables such as cables 54 connect one caisson of a mooring line to another caisson of an adjacent mooring line thus forming polygons having caissons at their vertices.

Schematic side view of mooring line 60 of the submersible mooring grid discussed above, is shown in FIG. 2B and disposed at a depth denoted by double arrow 62 below sea level 64. Caisson 66 disposed at one end of mooring line 60 is connected by means of downwardly suspended hawser 68 and chain 70 to anchor 72. Typically the chain used for the anchoring is longer than 50 meters. Anchoring of a caisson is achieved by a hawser, a chain, or a hawser in combination with a chain connected to an anchor. Some or all of the other caissons of a mooring line of the invention are either similarly anchored or stabilized by means of ballasts, such as ballast 74 suspended from caisson 76 by means of a cable, rope, hawser and or a chain. The buoyancies of all the caissons of mooring line 60 counterbalance the weights of the respective connecting hawsers, the suspended ballasts and/or the hanging sections of the chains attached to its respective caissons, and the mooring line is leveled at the proper depth. The depth below the sea level at which this mooring line is disposed is changeable by varying the buoyancies of the caissons. In FIG. 2C mooring line 76 is disposed at a level denoted by double arrow 77. At this level some or all the suspended ballasts may rest on the seabed such as is ballast 78. This level is deeper than the level denoted by arrow 62 shown in FIG. 2B to which reference is again made, such that devices retained by the submersible mooring grid are nor effected by a rough sea. Lowering of the level is achieved by respectively adding weights to the caissons of mooring line 60. The mooring line is to return to its initial level by relieving these additional weights.

The submersible mooring grid of the invention provides for keeping a device floating or submerged at pre-selected depths below sea level. Such can be applied to for example, fish cages, rafts, or mooring docks used for fishing, boating and or water sport activities that normally float when operational and are preferably submerged at rough sea conditions.

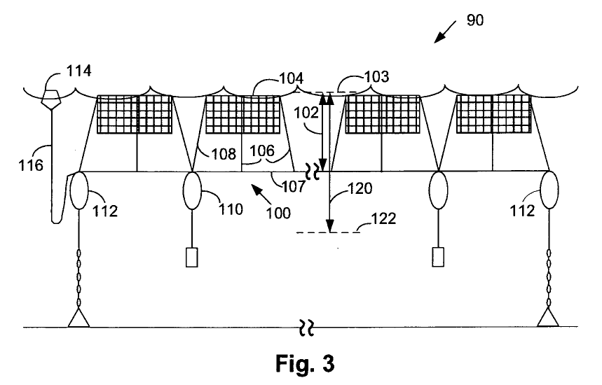

Reference is now made to FIG. 3 showing a schematic side view of submersible mooring grid 90 retaining fish cages according to a preferred embodiment of the present invention. Mooring line 100 is disposed at a depth denoted by double arrow 102 below sea level 103. This depth is such selected so that the topsides of the fish cages retained by this submersible mooring grid 90 and all their cage-floats, not shown, float at sea level 103. Each fish cage is tied to one or more adjacent mooring lines such as is cage 104 tied by means of cables 106 to connecting hawser 107 and/or by cable 108 to caisson 110. Typically fish cages tied to the mooring lines of the submersible mooring grid of the invention have near-neutral buoyancy. Both caissons 112 disposed at the ends of mooring line 100 are anchored. Downwardly suspended hawsers in combination with chain elements connect both caissons to anchors disposed on seabed. Signaling buoy 114, which is connected by cable 116 to one of the anchored caissons is typically equipped with a radio frequency (RF) reflector and/or a signaling light, both not shown, serving as an indicator of the submersible mooring grid.

Caissons of submersible mooring grid 90 have two compartments, the first compartment of which is hollow and is adapted to be filled with either air or water. The other compartment has a fixed weight and may also contain a fixed amount of water, concrete or any other weight as is known in the art. Pipes or tanks of any geometrical shape made of materials such as metals and/or plastic as known in the art, can replace the caissons in a mooring grid of the invention. In accordance with a preferred embodiment of the invention a flexible air duct interconnects the air inlets of the first compartments of all caissons. When air is pumped through this air duct into a first compartment any water possibly contained therein is cleared out. The inlet opening of the flexible air duct is hermetically sealed with a valve. Therefore the air within each of the first compartments of all caissons is locked and all caissons float at the same depth denoted by the double arrow 102. At this stage all the cage-floats of fish cages retained by the submersible mooring grid of the invention are disposed at the water surface. When the valve is opened air from each caisson escapes and water replaces it. Subsequently, the mooring lines and their respective caissons subside to a depth denoted by the double headed arrow 120. This depth is compatible with the length of the unbalanced segment of the chain elements suspended from the caissons and partially laid across the seabed. Lines 107 and 122 denote the first and second levels about which the caissons are submerged.

The inlet of flexible air duct, not shown, is attached to the signaling buoy 114 or to one of the buoys optionally attached to an anchored caisson. The length of the segment of the flexible air duct between this buoy and the corresponding nearest caisson is significantly longer than the maximal distance between this buoy and this caisson when the grid is fully immersed in the sea.

1. A mooring grid comprising at least one mooring line submersible at a changeable depth, wherein said at least one mooring line consists of
a substantially horizontal linear array of interconnected caissons;
a plurality of suspended members attached connected each to a respective caisson, and
wherein said suspended members are selected from a group consisting of cables, ropes, hawsers, chains and combinations of a hawser and a chain.

2. A submersible mooring grid as in claim 1, wherein at least one of said suspended member is further connected to a ballast.

3. A submersible mooring grid as in claim 1, wherein at least one of said suspended member is further connected to an anchor disposed on the seabed.

4. A submersible mooring grid as in claim 3, further comprising a signalling buoy connected to one of said caissons.

5. A submersible mooring grid as in claim 1, wherein at least one of said caissons has a hollow compartment having an air inlet.

6. A submersible mooring grid as in claim 5, further comprising a flexible air duct for feeding air to said air inlet.

7. A submersible mooring grid as in any of claims 1 through 6, wherein at least one fish cage is connected to at least one member of said at least one mooring line, and wherein said at least one member is selected from a group consisting of a caisson of said at least one mooring line and a connecting hawser of said at least one mooring line.
